(19) United States
(12) Patent Application Publication
(10) Pub. No.: US 2018/0248737 A1
(43) Pub. Date: Aug. 30, 2018

(54) Even-Length Sequence For Synchronization And Device Identification In Wireless Communication Systems

(71) Applicant: MediaTek Inc., Hsinchu City (TW)

(72) Inventors: Jiann-Ching Guey, Hsinchu City (TW); Chun-Hsuan Kuo, San Jose, CA (US); Chao-Cheng Su, Hsinchu City (TW); Lung-Sheng Tsai, Hsinchu City (TW)

(21) Appl. No.: 15/903,299

(22) Filed: Feb. 23, 2018

Related U.S. Application Data
(60) Provisional application No. 62/463,012, filed on Feb. 24, 2017.

(51) Int. Cl. H04L 27/26; H04J 13/00; H04J 13/22

(52) U.S. Cl. CPC H04L 27/2655; H04J 13/0062; H04L 5/0007; H04J 13/22; H04L 27/2613

(57) ABSTRACT

Techniques, schemes and examples pertaining to using even-length sequence for synchronization and device identification in wireless communications are described. A processor of an apparatus can generate a signal containing at least an even-length Zadoff-Chu (ZC) sequence and transmit the signal to a receiving device. The even-length ZC sequence identifies the apparatus, carries information for signaling, or functions in time-frequency synchronization. The processor can also receive a signal containing at least an even-length ZC sequence and detect the even-length ZC sequence in the received signal.

### CROSS REFERENCE TO RELATED PATENT APPLICATIONS

The present disclosure is part of a non-provisional application that claims the priority benefit of U.S. Provisional Patent Application No. 62/463,012, filed on 24 Feb. 2017. Content of above-listed application is herein incorporated by reference in its entirety.

### TECHNICAL FIELD

The present disclosure is generally related to mobile communications. In particular, the present disclosure is related to synchronization and device identification in mobile communication systems.

### BACKGROUND

Unless otherwise indicated herein, approaches described in this section are not prior art to the claims listed below and are not admitted as prior art by inclusion in this section.

In Long-Term Evolution (LTE) networks, odd-length Zadoff-Chu (ZC) sequences are used as primary synchronization signal (PSS), expressed as Equation 1 below.

$${Z}_{c} [ k ] = exp [ - \frac{j π uk ( k + 1 )}{N} ] \qquad ( 1 )$$

When N is an odd number, Z[k] is periodic with a period of N. The Inverse Discrete Fourier Transfer (IDFT) of Z[k] has a constant amplitude closed-form expression, shown as Equation 2 below.

$${z}_{c} [ n ] = exp [ \frac{j π n ( μ n - 1 )}{N} ] {z}_{c} [ 0 ] , {z}_{c} [ 0 ] = {\sum }_{k = 0}^{N - 1} exp [ - \frac{j π uk ( k + 1 )}{N} ] \qquad ( 2 )$$

In this expression, μ=1/u in the sense that mod (uμ, N)=1. When N is a prime number, cross correlation between two ZC sequences of different root indices u₁ and u₂ is square root of N if u₁ and u₂ are relative prime.

Typically, in LTE networks, the following values are chosen: N=63 with three root indices u=25, 29 and 34. The sequence Z[k] is placed in frequency domain of an orthogonal frequency-division multiplexing (OFDM) system, as OFDM systems typically employ Discrete Fourier Transform (DFT)/IDFT sizes that are power of 2 (e.g., 64, 128 and 256). However, DFT/IDFT of ZC sequences of these lengths do not have a closed form that can be used for efficient implementation of a detector in the time domain.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

In one aspect, a method may involve a processor of an apparatus generating a signal comprising at least an even-length ZC sequence. The method may also involve the processor transmitting the signal to a receiving device. The even-length ZC sequence may identify the apparatus, carry information for signaling, or function in time-frequency synchronization.

In one aspect, a method may involve a processor of an apparatus receiving a signal comprising at least an even-length ZC sequence. The method may also involve the processor detecting the even-length ZC sequence in the received signal. The even-length ZC sequence may identify the apparatus, carry information for signaling, or function in time-frequency synchronization.

### BRIEF DESCRIPTION OF THE DRAWINGS

The accompanying drawings are included to provide a further understanding of the present disclosure and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 is a diagram of an example of various ways that a composite sequence may be synthesized from two or more even-length ZC sequences in accordance with the present disclosure.

FIG. 2 is a diagram of an example scenario of synthesizing two even-length ZC sequences into a composite sequence using interleaved TDM in accordance with the present disclosure.

FIG. 3 is an example scenario of an approach for low-complexity detection in accordance with the present disclosure.

FIG. 4 is an example logic flow of an approach for low-complexity detection in accordance with the present disclosure.

FIG. 5 is an example scenario of an approach for low-complexity detection in accordance with the present disclosure.

FIG. 6 is an example scenario of an approach for low-complexity detection in accordance with the present disclosure.

FIG. 7 is an example logic flow of an approach for low-complexity detection in accordance with the present disclosure.

FIG. 8 is an example scenario of an approach for over-sampling of a received signal in accordance with the present disclosure.

FIG. 9 is an example table with respect to two sequences for composite sequence in accordance with the present disclosure.

FIG. 10 is an example scenario of composite sequence in accordance with the present disclosure.

FIG. 11 is an example logic flow of an approach for composite sequence in accordance with the present disclosure.

FIG. 12 is a diagram of an example wireless communication system in accordance with the present disclosure.

FIG. 13 is a flowchart of a process in accordance with the present disclosure.

FIG. 14 is a flowchart of a process in accordance with the present disclosure.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### Overview

Under a proposed scheme of the present disclosure, an even-length ZC sequence, expressed below as Equation 3, may be utilized for PSS.

$$Z [ k ] = exp [ - \frac{j π {uk}^{2}}{N} ] \qquad ( 3 )$$

In Equation 3, N is a power of 2 and the root index u is an odd number. The IDFT of Z[k] can be expressed as Equation 4 below.

$$z [ n ] = exp [ \frac{j πμ {n}^{2}}{N} ] z [ 0 ] , z [ 0 ] = {\sum }_{k = 0}^{N - 1} exp [ - \frac{j π {uk}^{2}}{N} ] \qquad ( 4 )$$

Here, mod (uμ, N)=1. Moreover, the constant amplitude zero auto-correlation (CAZAC) property is preserved.

Under the proposed scheme of the present disclosure, another even-length sequence, expressed below as Equation 5, may be derived by extending the odd-length ZC sequence by one sample.

$$z [ n ] = exp [ \frac{- j π un ( n + 1 )}{N} ] , n = 0 , … , N or \\ z [ n ] = exp [ \frac{j π n ( μ n - 1 )}{N} ] z [ 0 ] , n = 0 , … , N \qquad ( 5 )$$

When the sequence is placed in the time domain, all embodiments in accordance with the present disclosure, including those described herein, are applicable. Moreover, under the proposed scheme, a sequence in the frequency domain may be expressed below as Equation 6.

$$Z [ k ] = {\sum }_{n = 0}^{N} z [ n ] exp [ - \frac{j 2 π nk}{N + 1} ] \qquad ( 6 )$$

In a first embodiment in accordance with the present disclosure, in the context of stand-alone usage with respect to transmitting/transmitters (TX), a single sequence may be transmitted by a communication device for a variety of purposes including, for example and without limitation, device identification, signaling, and time-frequency synchronization. In terms of signaling, a signaling purpose may include the identification of the transmission by a specific beamformer. Additionally, another signaling purpose may include the identification of timing index in a sequence of transmitted signals. For identification and signaling, the transmission of the single sequence may be carried by cyclic or non-cyclic time-frequency shifts of the sequence with root index u. It is noteworthy that the single sequence may be used in time domain or frequency domain.

In a second embodiment in accordance with the present disclosure, also with respect to transmissions, two or more even-length ZC sequences may be synthesized into a composite sequence in various manners. For instance, two or more even-length ZC sequences may be synthesized into a composite sequence using contiguous or non-contiguous frequency division multiplexing (FDM) and/or interleaved FDM. Alternatively, two or more even-length ZC sequences may be synthesized into a composite sequence using contiguous or non-contiguous time division multiplexing (TDM) and/or interleaved TDM. Alternatively, two or more even-length ZC sequences may be synthesized into a composite sequence using code division multiplexing (CDM), e.g., with multiple component sequences transmitted simultaneously at the same frequency. Alternatively, two or more even-length ZC sequences may be synthesized into a composite sequence using a combination of FDM and TDM. It is noteworthy that the two or more even-length ZC sequences may be of the same length or different lengths. Moreover, the two or more even-length ZC sequences may have the same index or different indices. In the case of a composite sequence derived from the multiplexing of two component sequences, the two root indices may be selected to be conjugate to each other such as, for example, u₁=−u₂.

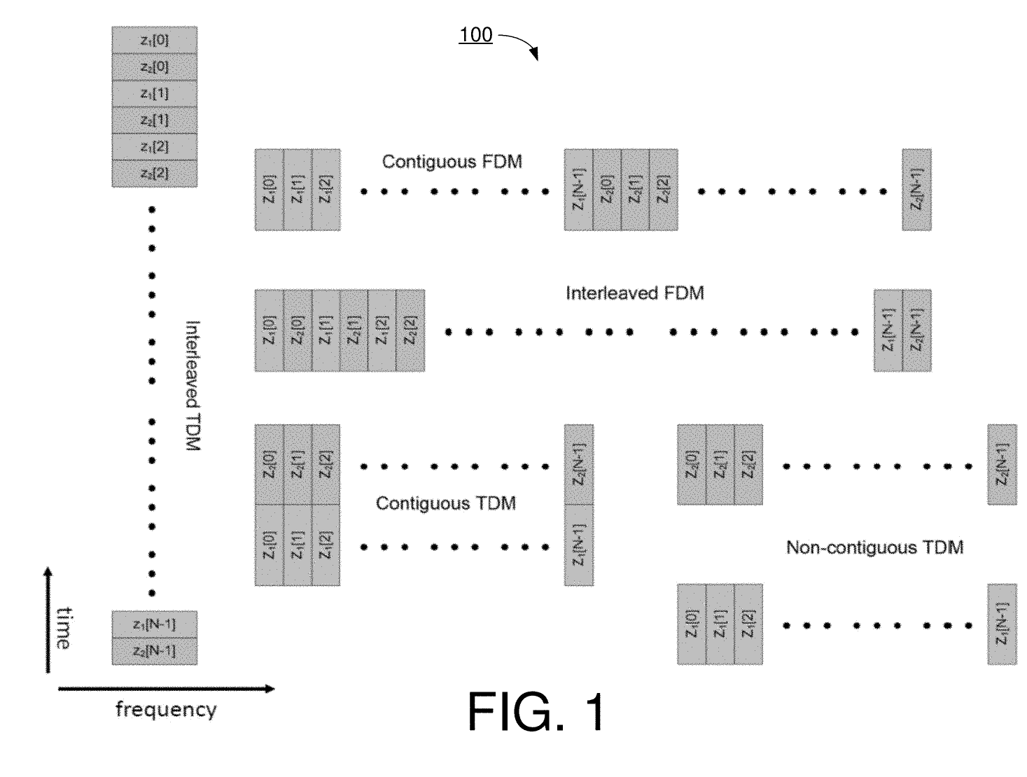

FIG. 1 provides an example 100 of the various ways that a composite sequence may be synthesized or otherwise formed from two or more even-length ZC sequences in accordance with the present disclosure. Referring to FIG. 1, two or more even-length ZC sequences may be synthesized by interleaved time division multiplexing (TDM), contiguous TDM, non-contiguous TDM, contiguous frequency division multiplexing (FDM), interleaved FDM. It is noteworthy that FIG. 1 is merely provided as an illustrative example and does not limit the ways on how two or more even-length ZC sequences may be synthesized to form a composite sequence. For instance, two or more even-length ZC sequences may be synthesized by code division multiplexing (CDM) to form a composite sequence.

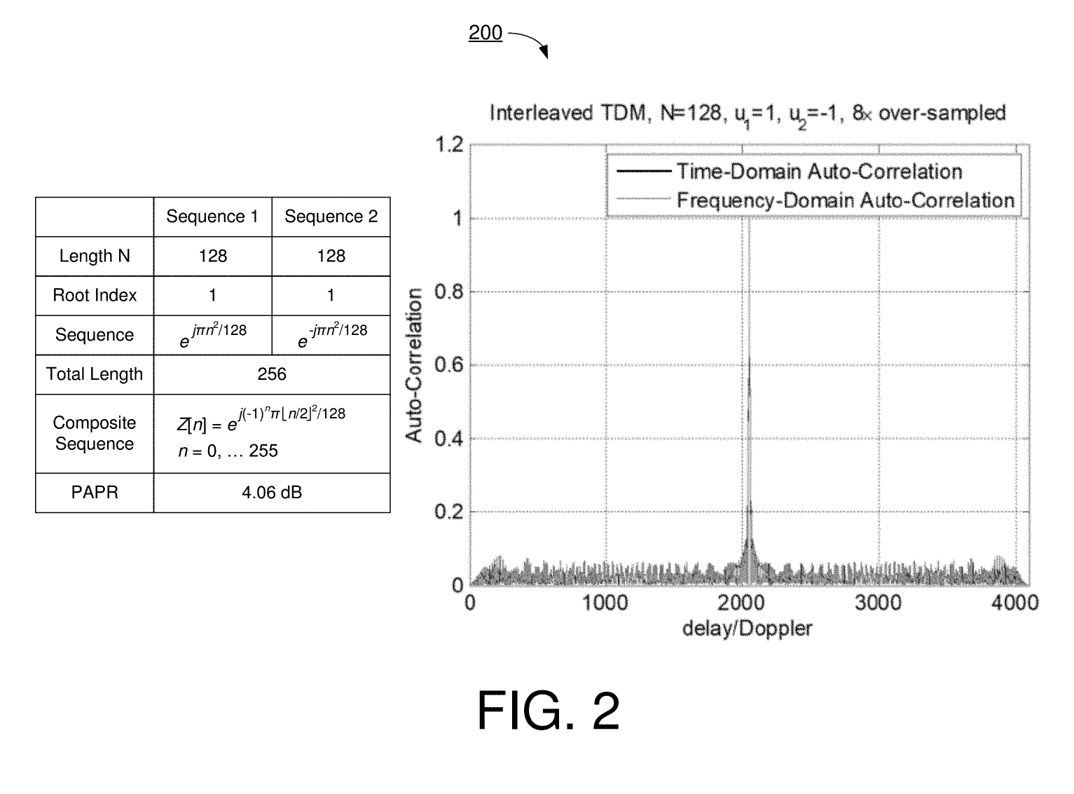

FIG. 2 provides an example scenario 200 of synthesizing two even-length ZC sequences (denoted as “Sequence 1” and “Sequence 2”) into a composite sequence using interleaved TDM in accordance with the present disclosure.

In a third embodiment in accordance with the present disclosure, in the context of low-complexity detection with respect to receiving/receivers (RX), the detection of the sequence may involve a two-dimensional correlator, as expressed as Equation 7 below.

$$\begin{matrix}λ [ τ , v ] = {\sum }_{n = τ}^{τ + N - 1} r [ n ] {z}^{*} [ n - τ ] {e}^{\frac{- j 2 π vn}{N}} \\ = {\sum }_{n = τ}^{τ + N - 1} r [ n ] exp \{ \frac{- j {πμ ( n - τ )}^{2}}{N} \} {z}^{*} [ 0 ] {e}^{\frac{- j 2 π vn}{N}} \\ = {λ}_{c} {\sum }_{n = τ}^{τ + N - 1} r [ n ] {e}^{\frac{- j πμ {n}^{2}}{N}} exp \{ \frac{- j 2 π n ( v - μτ )}{N} \}\end{matrix} \qquad ( 7 )$$

In Equation 7, [τ, v] is the time-frequency offset hypothesis. The range of v depends on the frequency raster (potential center frequency of the transmitted sequence) and the accuracy of the oscillator of the communication device that transmits the sequence.

In the third embodiment, on the RX side, the received signal may be decomposed in two stages, namely: (1) phase-unwrapping the received signal, and (2) performing sample-by-sample sliding DFT.

The phase-unwrapped received signal may be expressed below as Equation 8.

$$\tilde{r} [ n ] = r [ n ] {e}^{\frac{- j πμ {n}^{2}}{N}} \qquad ( 8 )$$

The sample-by-sample sliding DFT to find the maximum (max) k=k₀ may be expressed below as Equation 9.

$${\tilde{R}}_{τ} [ k ] = {\sum }_{n = τ}^{τ + N - 1} \tilde{r} [ n ] {e}^{\frac{- j 2 π nk}{N}} \qquad ( 9 )$$

The detected time-frequency offset may be expressed below as Equation 10.

v₀=k₀+μτ₀ (10)

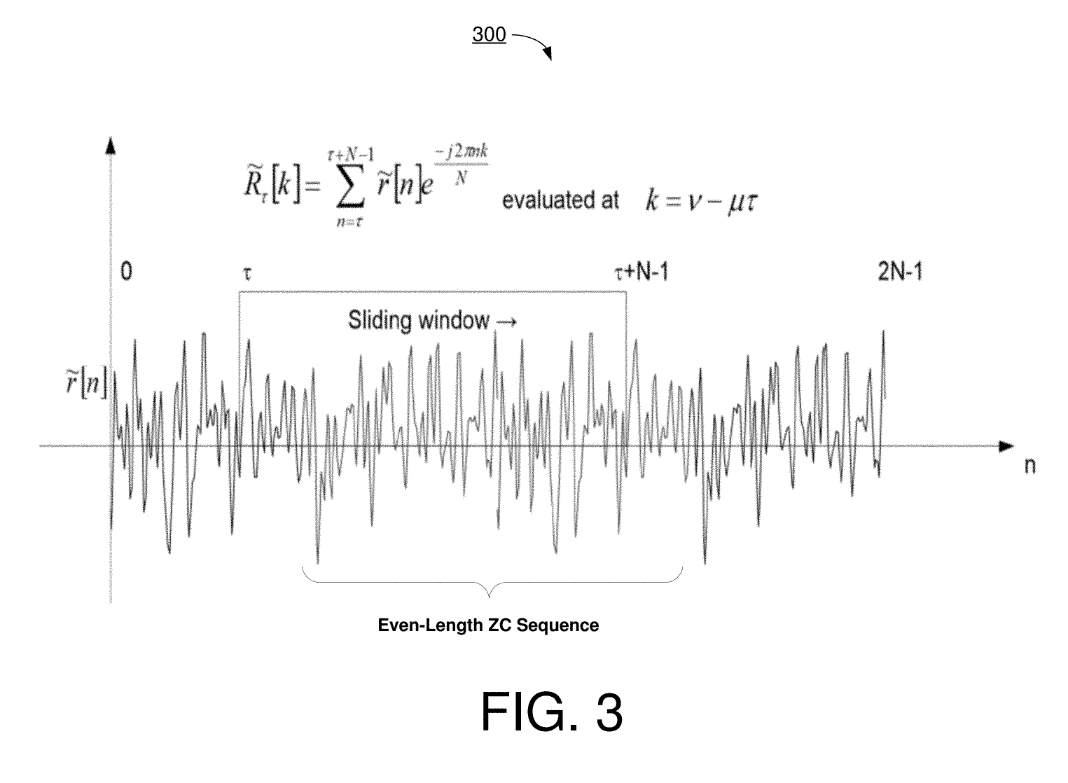

FIG. 3 illustrates an example scenario 300 of an approach for low-complexity detection in accordance with the present disclosure. Referring to FIG. 3, τ and v are searched jointly by a single DFT. There are N multiplications per sample using sliding DFT, for all time-frequency hypotheses, instead of N².

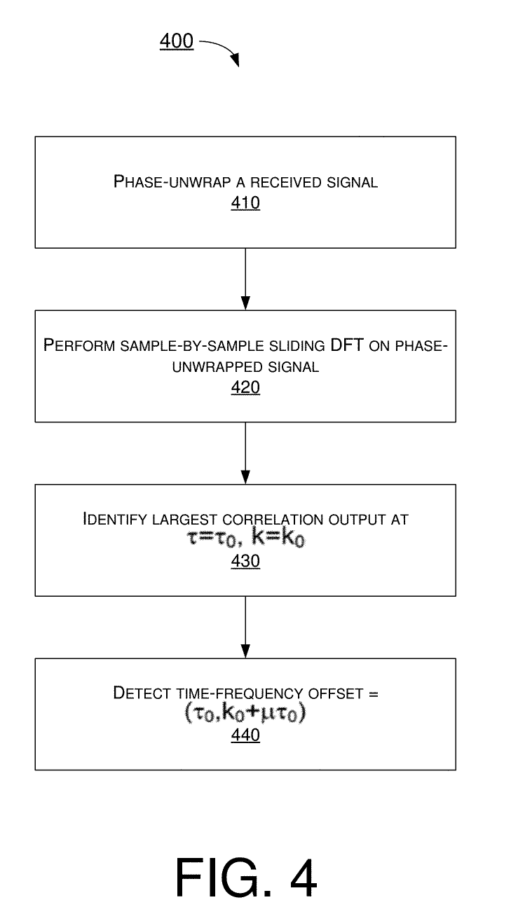

FIG. 4 illustrates an example logic flow 400 of an approach for low-complexity detection in accordance with the third embodiment of the present disclosure. Logic flow 400 may represent an aspect of implementing the proposed concepts and schemes with respect to decomposing a received signal in two stages. Logic flow 400 may include one or more operations, actions, or functions as illustrated by one or more of blocks 410, 420, 430 and 440. Although illustrated as discrete blocks, various blocks of logic flow 400 may be divided into additional blocks, combined into fewer blocks, or eliminated, depending on the desired implementation. Moreover, the blocks of logic flow 400 may be executed in the order shown in FIG. 4 or, alternatively in a different order. The blocks of logic flow 400 may be executed iteratively. Logic flow 400 may begin at block 410.

At 410, logic flow 400 may involve a receiver phase-unwrapping a received signal to provide a phase-unwrapped signal. Logic flow 400 may proceed from 410 to 420.

At 420, logic flow 400 may involve the receiver performing sample-by-sample sliding DFT on the phase-unwrapped signal. Logic flow 400 may proceed from 420 to 430.

At 430, logic flow 400 may involve the receiver identifying or otherwise finding the maximum correlation output at τ=τ₀, k=k₀ based on a result of the sample-by-sample DFT. Logic flow 400 may proceed from 430 to 440.

At 440, logic flow 400 may involve the receiver detecting or otherwise determining a time-frequency offset, (τ₀, k₀+ρτ₀), using the maximum correlation output.

In a fourth embodiment in accordance with the present disclosure, in the context of low-complexity detection with respect to RX, the received signal may be decomposed in three stages, namely: (1) phase-unwrapping the received signal, (2) performing partially overlapped sample-by-sample sliding DFT (POSD) to detect presence of signal within a window, and (3) performing local refinement using sample-by-sample sliding DFT as described above.

The phase-unwrapped received signal may be expressed below as Equation 11.

$$\tilde{r} [ n ] = r [ n ] {e}^{\frac{- j πμ {n}^{2}}{N}} \qquad ( 11 )$$

The POSD to detect presence of signal within a window may be expressed below as Equation 12, dropping τ in the sum.

$${\tilde{R}}_{τ} [ k ] = {\sum }_{n = τ}^{τ + N - 1} \tilde{r} [ n ] {e}^{\frac{- j 2 π nk}{N}} \approx {\sum }_{n = 0}^{2 N - 1} \tilde{r} [ n ] {e}^{\frac{- j 2 π nk}{N}} ≡ \tilde{R} [ k ] \qquad ( 12 )$$

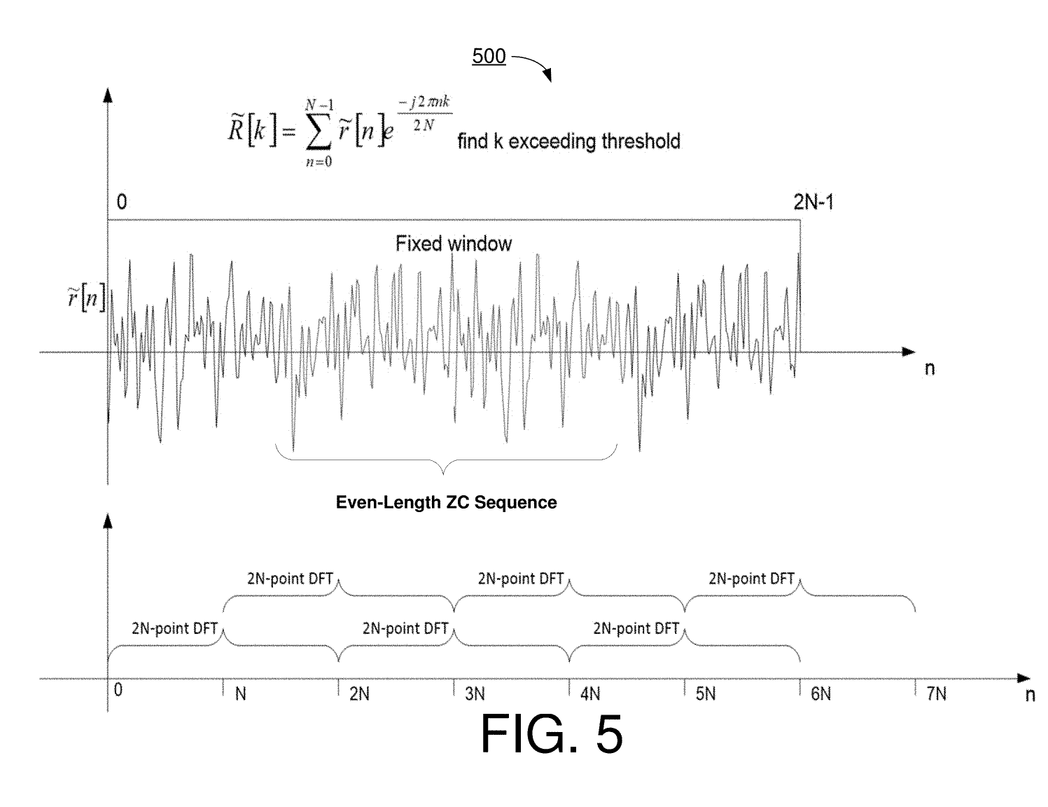

FIG. 5 illustrates an example scenario 500 of another approach for low-complexity detection in accordance with the present disclosure. Referring to FIG. 5, this approach involves one multiplication per sample for phase-unwrapping, length-2N DFT per N samples, and 2Nlog₂ (2/N)/N+1=2 log₂N+1 multiplications per sample for all time-frequency hypotheses.

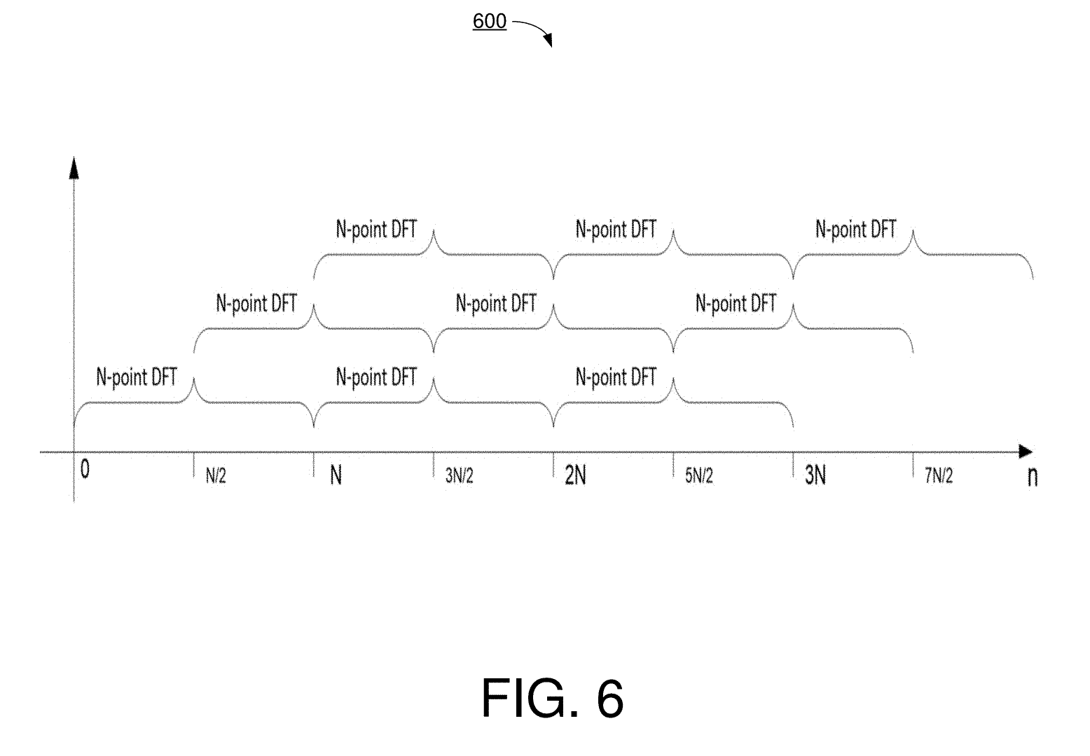

Under the proposed scheme, the window size and overlapping interval may be different. FIG. 6 illustrates an example scenario 600 of yet another approach for low-complexity detection in accordance with the present disclosure. Referring to FIG. 6, this approach involves one multiplication per sample for phase-unwrapping, length-N DFT per N/2 samples, and Nlog₂ N/(N/2)+1=2 log₂N+1 multiplications per sample for all time-frequency hypotheses.

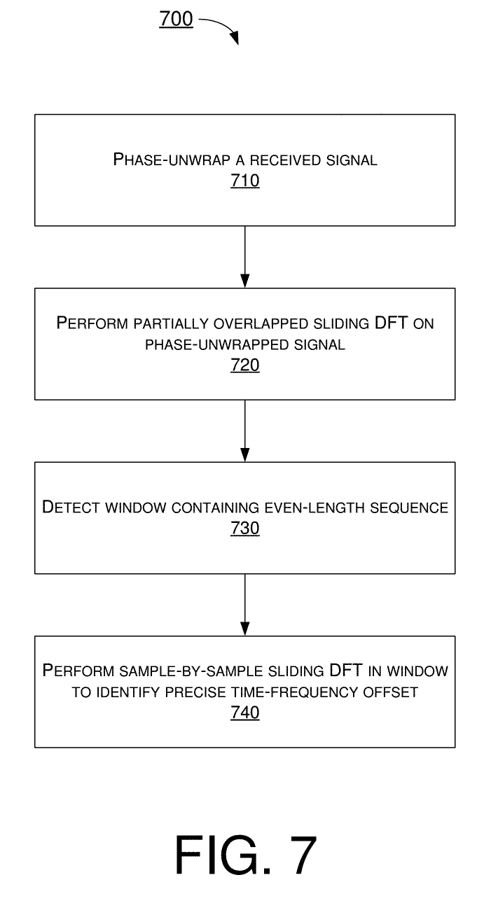

FIG. 7 illustrates an example logic flow 700 of an approach for low-complexity detection in accordance with the third embodiment of the present disclosure. Logic flow 700 may represent an aspect of implementing the proposed concepts and schemes with respect to decomposing a received signal in two stages. Logic flow 700 may include one or more operations, actions, or functions as illustrated by one or more of blocks 710, 720, 730 and 740. Although illustrated as discrete blocks, various blocks of logic flow 700 may be divided into additional blocks, combined into fewer blocks, or eliminated, depending on the desired implementation. Moreover, the blocks of logic flow 700 may be executed in the order shown in FIG. 7 or, alternatively in a different order. The blocks of logic flow 700 may be executed iteratively. Logic flow 700 may begin at block 710.

At 710, logic flow 700 may involve a receiver phase-unwrapping a received signal to provide a phase-unwrapped signal. Logic flow 700 may proceed from 710 to 720.

At 720, logic flow 700 may involve the receiver performing partially overlapped sliding DFT on the phase-unwrapped signal. Logic flow 700 may proceed from 720 to 730.

At 730, logic flow 700 may involve the receiver detecting or otherwise identifying a window (e.g., time window) containing an even-length ZC sequence based on a result of the partially overlapped sliding DFT. Logic flow 700 may proceed from 730 to 740.

At 740, logic flow 700 may involve the receiver performing sample-by-sample sliding DFT in the detected window to identify, detect or otherwise determine a precise time-frequency offset.

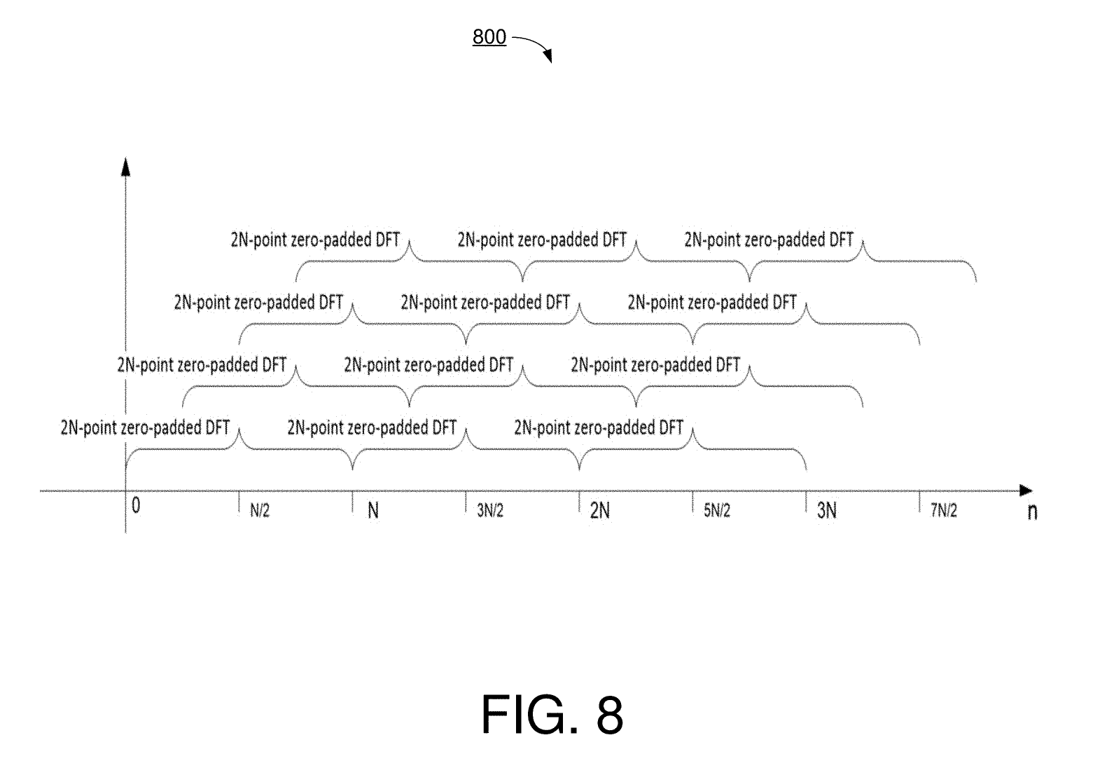

In a fifth embodiment in accordance with the present disclosure, in the context of over-sampled received signal with respect to RX, over-sampling may be performed in the frequency domain or in the time domain. Regarding over-sampling in the frequency domain, the fifth embodiment may involve performing a zero-padded sliding DFT, as shown in FIG. 8, which illustrates an example scenario 800 of an approach for over-sampling of a received signal in accordance with the present disclosure.

Regarding over-sampling in the time domain, given M times over-sampled received signal r_{⬆}[n], serial to parallel processing to M streams may be expressed below as Equation 13.

rₘ[n]=r_{⬆}[Mn+m], for m=0, . . . , M−1 (13)

In the fifth embodiment, each stream may go through a two-stage pipeline (phase-unwrapping and sample-by-sample sliding DFT) or three-stage pipeline (phase-unwrapping, partially overlapped sample-by-sample sliding DFT, and local refinement using sample-by-sample sliding DFT). The outputs of the multiple streams may be combined coherently or non-coherently to achieve better performance.

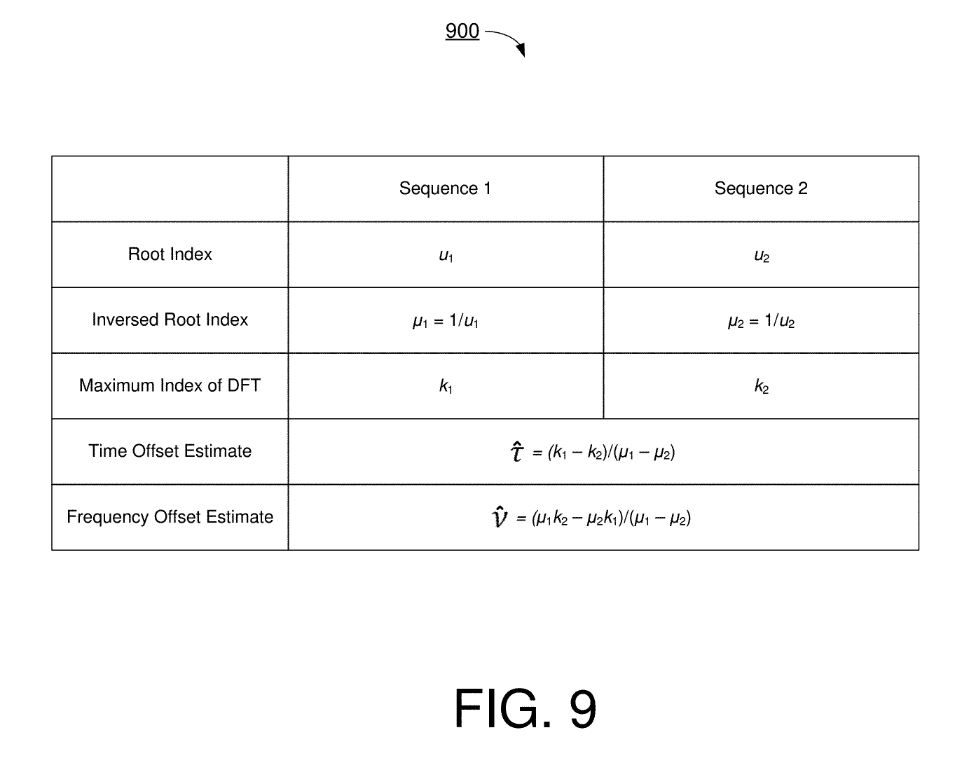

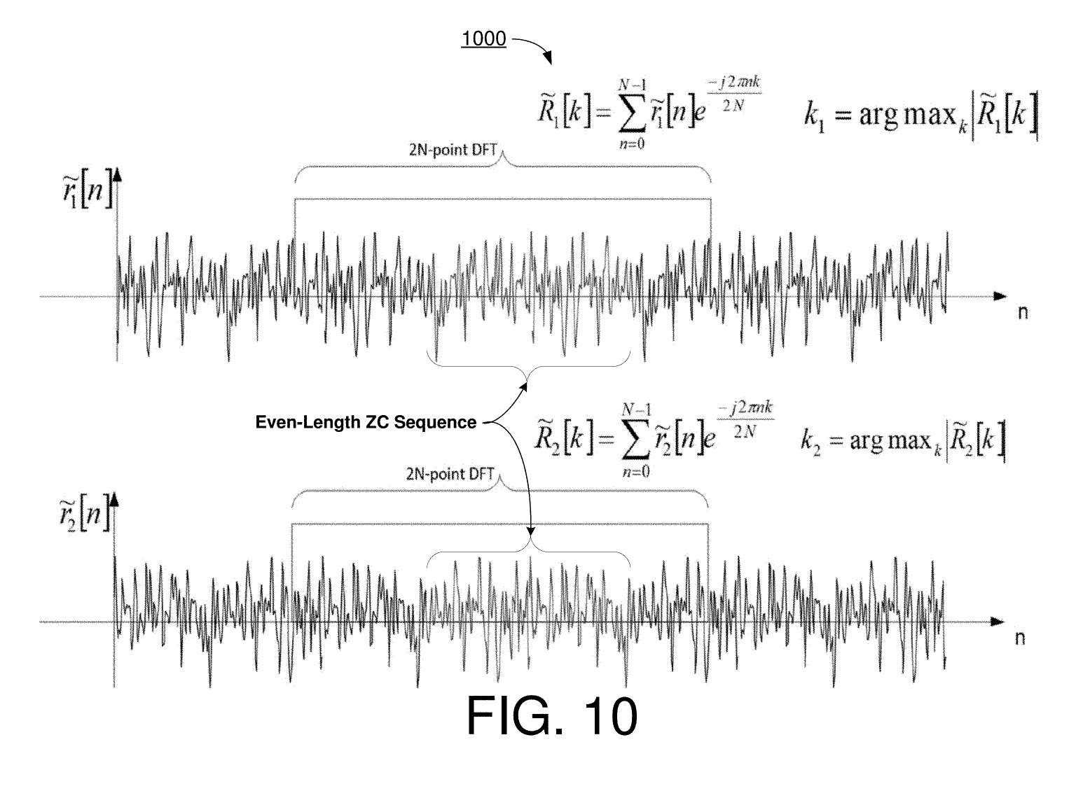

In a sixth embodiment in accordance with the present disclosure, in the context of composite sequence with respect to RX, two sequences with different root indices u₁ and u₂ may be transmitted, and two correlators may be run in parallel with each corresponding to a respective one of the two different root indices. The two sequences with different root indices may be transmitted using TDM, FDM, CDM, or any combination of TDM, FDM and CDM. A frequency bin with the highest magnitude at an output of sliding DFT for each correlator may be identified. Then, linear equations may be solved to find time-frequency offset. FIG. 9 shows an example table 900 with respect to two sequences, u₁ and u₂, for composite sequence in accordance with the present disclosure. FIG. 10 illustrates an example scenario 1000 of composite sequence in accordance with the present disclosure.

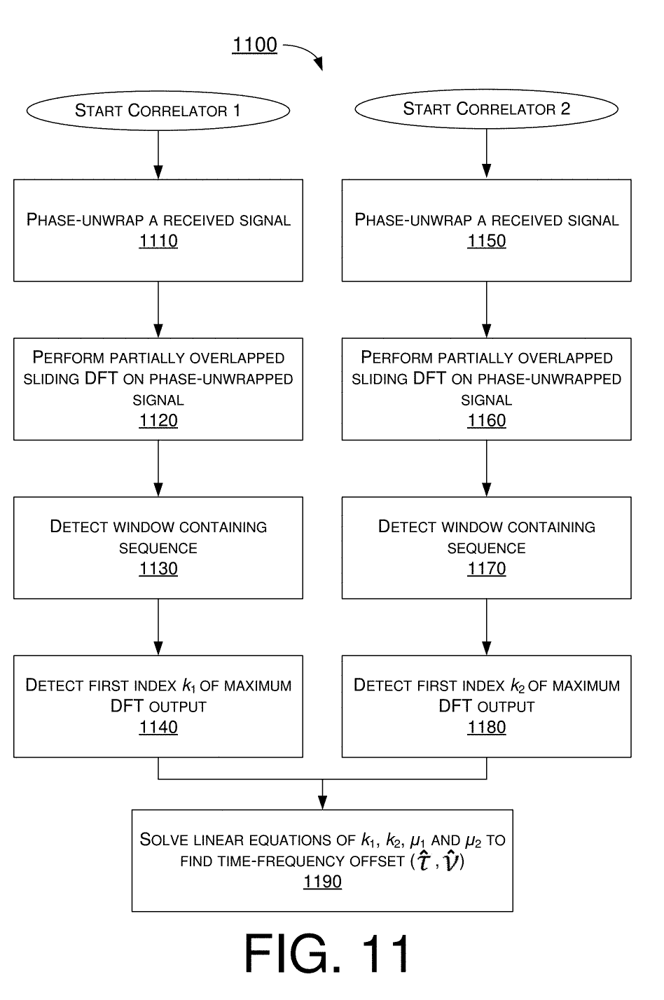

FIG. 11 illustrates an example logic flow 1100 of an approach for low-complexity detection in accordance with the sixth embodiment of the present disclosure. That is, logic flow 1100 may be utilized when a composite sequence is received, and the composite sequence is composed of two even-length ZC sequences having two different root indices. Logic flow 1100 may represent an aspect of implementing the proposed concepts and schemes with respect to decomposing a received signal in two stages. Logic flow 1100 may include one or more operations, actions, or functions as illustrated by one or more of blocks 1110, 1120, 1130, 1140, 1150, 1160, 1170, 1180 and 1190. As shown in FIG. 11, blocks 1110˜1140 pertain to a first correlator (denoted as “Correlator 1”) while blocks 1150˜1180 pertain to a second correlator (denoted as “Correlator 2”). Although illustrated as discrete blocks, various blocks of logic flow 1100 may be divided into additional blocks, combined into fewer blocks, or eliminated, depending on the desired implementation. Moreover, the blocks of logic flow 1100 may be executed in the order shown in FIG. 11 or, alternatively in a different order. The blocks of logic flow 1100 may be executed iteratively. Logic flow 1100 may begin at block 1110 (for Correlator 1) and/or block 1150 (for Correlator 2).

At 1110, logic flow 1100 may involve a receiver phase-unwrapping a received signal to provide a first phase-unwrapped signal. Logic flow 1100 may proceed from 1110 to 1120.

At 1120, logic flow 1100 may involve the receiver performing partially overlapped sliding DFT on the first phase-unwrapped signal. Logic flow 1100 may proceed from 1120 to 1130.

At 1130, logic flow 1100 may involve the receiver detecting or otherwise identifying a first window (e.g., time window) containing a first even-length ZC sequence. Logic flow 1100 may proceed from 1130 to 1140.

At 1140, logic flow 1100 may involve the receiver detecting, determining, identifying or otherwise finding, for the first even-length ZC sequence, a first index k₁ of a maximum DFT output. Logic flow 1100 may proceed from 1140 to 1190.

At 1150, logic flow 1100 may involve the receiver phase-unwrapping the received signal to provide a second phase-unwrapped signal. Logic flow 1100 may proceed from 1150 to 1160.

At 1160, logic flow 1100 may involve the receiver performing partially overlapped sliding DFT on the second phase-unwrapped signal. Logic flow 1100 may proceed from 1160 to 1170.

At 1170, logic flow 1100 may involve the receiver detecting or otherwise identifying a second window (e.g., time window) containing a second even-length ZC sequence. Logic flow 1100 may proceed from 1170 to 1180.

At 1180, logic flow 1100 may involve the receiver detecting, determining, identifying or otherwise finding, for the second even-length ZC sequence, a second index k₂ of a maximum DFT output. Logic flow 1100 may proceed from 1180 to 1190.

At 1190, logic flow 1100 may involve the receiver determining, identifying or otherwise finding a time-frequency offset, (\hat{τ}, \hat{v}), by solving linear Equations 14 of k₁, k₂, μ₁ and μ₂ as follows:

\hat{τ}=(k₂−k₁)/(μ₁−μ₂),\hat{v}=(μ₁k₂−μ₂k₁)/(μ₁−μ₂). (14)

In view of the above, it is believed that those of ordinary skill in the art would appreciate that even-length ZC sequences preserve CAZAC property of odd-length ZC sequences. Moreover, an even-length ZC sequence facilitates low-complexity conversion of the sequence between time and frequency domains using FFT. Time-domain sequences may be detected with a low-complexity detector. The complexity of the detector does not scale up with the number of possible frequency offsets between the TX and RX devices. Additionally, under the proposed scheme, arbitrary raster locations are permissible, thereby allowing a raster-less design. Furthermore, the proposed scheme allows for relaxed requirement for oscillator accuracy.

### Illustrative Implementations

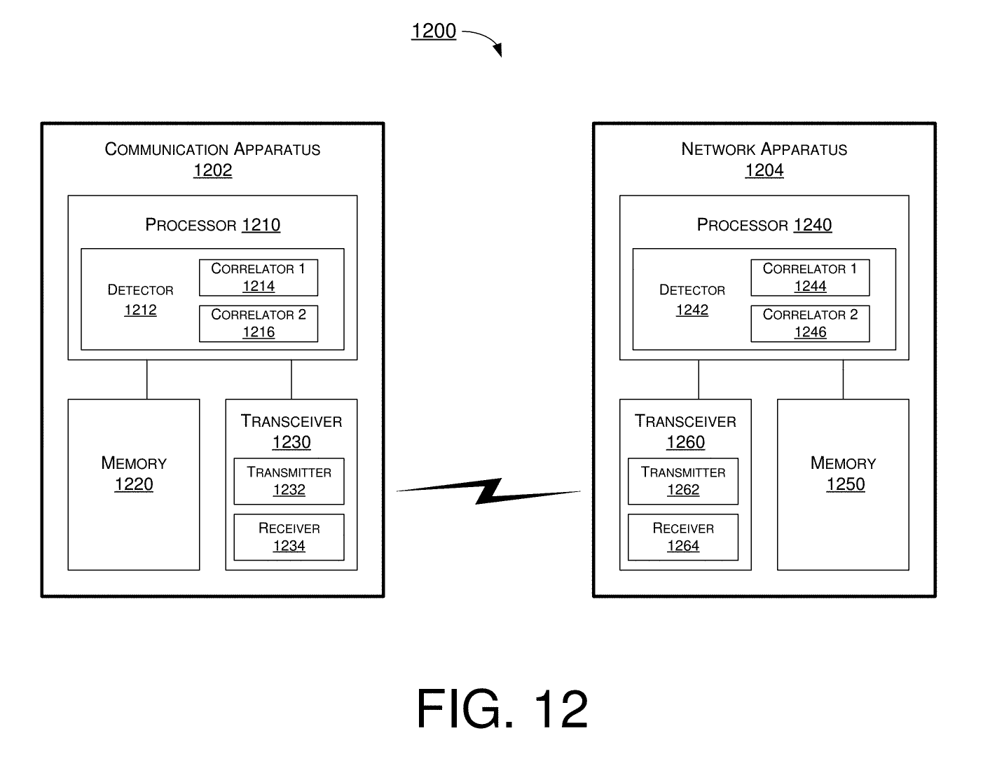

FIG. 12 illustrates an example wireless communication system 1200 that includes at least an example communication apparatus 1202 and an example network apparatus 1204 in accordance with an implementation of the present disclosure. Each of communication apparatus 1202 and network apparatus 1204 may perform various functions to implement schemes, techniques, processes and methods described herein pertaining to using even-length sequence for synchronization and device identification in wireless communications, including those described above with respect to FIG. 1˜FIG. 11 as well as processes 1300 and 1400 described below.

Communication apparatus 1202 may be a part of an electronic apparatus, which may be a user equipment (UE) such as a portable or mobile apparatus, a wearable apparatus, a wireless communication apparatus or a computing apparatus. For instance, communication apparatus 1202 may be implemented in a smartphone, a smartwatch, a personal digital assistant, a digital camera, or a computing equipment such as a tablet computer, a laptop computer or a notebook computer. Communication apparatus 1202 may also be a part of a machine type apparatus, which may be an IoT or NB-IoT apparatus such as an immobile or a stationary apparatus, a home apparatus, a wire communication apparatus or a computing apparatus. For instance, communication apparatus 1202 may be implemented in a smart thermostat, a smart fridge, a smart door lock, a wireless speaker or a home control center. Alternatively, communication apparatus 1202 may be implemented in the form of one or more integrated-circuit (IC) chips such as, for example and without limitation, one or more single-core processors, one or more multi-core processors, or one or more complex-instruction-set-computing (CISC) processors. Communication apparatus 1202 may include at least some of those components shown in FIG. 12 such as a processor 1210, for example. Communication apparatus 1202 may further include one or more other components not pertinent to the proposed scheme of the present disclosure (e.g., internal power supply, display device and/or user interface device), and, thus, such component(s) of communication apparatus 1202 are neither shown in FIG. 12 nor described below in the interest of simplicity and brevity.

Network apparatus 1204 may be a part of an electronic apparatus, which may be a network node such as a base station, a small cell, a router or a gateway. For instance, network apparatus 1204 may be implemented in an eNodeB in a LTE, LTE-Advanced or LTE-Advanced Pro network or in a gNB in a 5G, NR, IoT or NB-IoT network. Alternatively, network apparatus 1204 may be implemented in the form of one or more IC chips such as, for example and without limitation, one or more single-core processors, one or more multi-core processors, or one or more CISC processors. Network apparatus 1204 may include at least some of those components shown in FIG. 12 such as a processor 1240, for example. Network apparatus 1204 may further include one or more other components not pertinent to the proposed scheme of the present disclosure (e.g., internal power supply, display device and/or user interface device), and, thus, such component(s) of network apparatus 1204 are neither shown in FIG. 12 nor described below in the interest of simplicity and brevity.

In one aspect, each of processor 1210 and processor 1240 may be implemented in the form of one or more single-core processors, one or more multi-core processors, or one or more CISC processors. That is, even though a singular term “a processor” is used herein to refer to processor 1210 and processor 1240, each of processor 1210 and processor 1240 may include multiple processors in some implementations and a single processor in other implementations in accordance with the present disclosure. In another aspect, each of processor 1210 and processor 1240 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1210 and processor 1240 is a special-purpose machine specifically designed, arranged and configured to perform specific tasks including using even-length sequence for synchronization and device identification in wireless communications in accordance with various implementations of the present disclosure. In some implementations, processor 1210 may include a detector 1212, which may include a first correlator 1214 (denoted as “correlator 1”) and a second correlator 1216 (denoted as “correlator 2”). In some implementations, processor 1240 may include a detector 1242, which may include a first correlator 1244 (denoted as “correlator 1”) and a second correlator 1246 (denoted as “correlator 2”).

In some implementations, communication apparatus 1202 may also include a transceiver 1230 coupled to processor 1210 and capable of wirelessly transmitting and receiving data. Specifically, transceiver 1230 may include a transmitter 1232 and a receiver 1234 capable of wireless transmission and wireless receiving, respectively. In some implementations, communication apparatus 1202 may further include a memory 1220 coupled to processor 1210 and capable of being accessed by processor 1210 and storing data therein. In some implementations, network apparatus 1204 may also include a transceiver 1260 coupled to processor 1240 and capable of wirelessly transmitting and receiving data. Specifically, transceiver 1260 may include a transmitter 1262 and a receiver 1264 capable of wireless transmission and wireless receiving, respectively. In some implementations, network apparatus 1204 may further include a memory 1250 coupled to processor 1240 and capable of being accessed by processor 1240 and storing data therein. Accordingly, communication apparatus 1202 and network apparatus 1204 may wirelessly communicate with each other via transceiver 1230 and transceiver 1260, respectively. To aid better understanding, the following description of the operations, functionalities and capabilities of each of communication apparatus 1202 and network apparatus 1204 is provided in the context of a mobile communication environment in which communication apparatus 1202 is implemented in or as a communication apparatus or a UE and network apparatus 1204 is implemented in or as a network node of a communication network.

In some implementations, processor 1210 of communication apparatus 1202 may generate a signal comprising at least an even-length ZC sequence, and processor 1210 may transmit, via transmitter 1232 of transceiver 1230, the signal to a receiving device (e.g., receiver 1264 of transceiver 1260 of network apparatus 1204). The even-length ZC sequence may identify communication apparatus 1202, carry information for signaling, or function in time-frequency synchronization.

In some implementations, a length of the even-length ZC sequence may be a power of 2.

In some implementations, in generating the signal comprising the even-length ZC sequence, processor 1210 may generate the even-length ZC sequence in a time domain. Alternatively, in generating the signal comprising the even-length ZC sequence, processor 1210 may generate the even-length ZC sequence in a frequency domain.

In some implementations, the even-length ZC sequence may function for either or both of device identification and signaling. In such cases, in transmitting the signal, processor 1210 may transmit, via transmitter 1232 of transceiver 1230, the even-length ZC sequence with information of either or both of device identification and signaling carried by either of: (1) a cyclic or non-cyclic time-frequency shift of the even-length ZC sequence and (2) a root index of the even-length ZC sequence.

In some implementations, in generating the signal, processor 1210 may generate the signal by synthesizing two or more even-length ZC sequences into a composite sequence. Moreover, in synthesizing the two or more even-length ZC sequences into the composite sequence, processor 1210 may synthesize the two or more even-length ZC sequences using: (1) contiguous or non-contiguous FDM or interleaved FDM, (2) contiguous or non-contiguous TDM or interleaved TDM, (3) CDM, or (4) a combination of some or all of the FDM, TDM and CDM (e.g., FDM plus TDM, FDM plus CDM, TDM plus CDM, or FDM plus TDM plus CDM).

In some implementations, the two or more even-length ZC sequences may be of a same length. Alternatively, the two or more even-length ZC sequences may be of different lengths.

In some implementations, the two or more even-length ZC sequences may have a same root index. Alternatively, the two or more even-length ZC sequences may have different root indices.

In some implementations, the two or more even-length ZC sequences may include two even-length ZC sequences having two different root indices, and the two different root indices may be conjugate to each other.

In some implementations, processor 1210 may receive, via receiver 1234 of transceiver 1230 (e.g., from network apparatus 1204), a signal comprising at least an even-length ZC sequence, and processor 1210 may detect the even-length ZC sequence in the received signal. The even-length ZC sequence may identify the apparatus, carry information for signaling, or function in time-frequency synchronization.

In some implementations, in detecting the even-length ZC sequence in the received signal, detector 1212 of processor 1210 may perform a number of operations. For instance, detector 1212 may phase-unwrap the received signal to provide a phase-unwrapped signal. Additionally, detector 1212 may perform sample-by-sample sliding DFT on the phase-unwrapped signal. Moreover, detector 1212 may identify a maximum correlation output based on a result of the sample-by-sample DFT. Furthermore, detector 1212 may determine a time-frequency offset using the maximum correlation output.

In some implementations, in detecting the even-length ZC sequence in the received signal, detector 1212 of processor 1210 may perform a number of operations. For instance, detector 1212 may phase-unwrap the received signal to provide a phase-unwrapped signal. Additionally, detector 1212 may perform partially overlapped sliding DFT on the phase-unwrapped signal. Moreover, detector 1212 may detect a window containing the even-length ZC sequence based on a result of the partially overlapped sliding DFT. Furthermore, detector 1212 may perform sample-by-sample sliding DFT in the detected window to determine a time-frequency offset.

In some implementations, in detecting the even-length ZC sequence in the received signal, detector 1212 may over-sample the received signal in a frequency domain such that a resolution of detection of the even-length ZC sequence is increased. In some implementations, in over-sampling the received signal in the frequency domain, detector 1212 may perform a zero-padded sliding DFT on the received signal.

In some implementations, in detecting the even-length ZC sequence in the received signal, detector 1212 may over-sample the received signal in a time domain such that a range of detection of the even-length ZC sequence in a frequency domain is increased. In some implementations, in over-sampling the received signal in the time domain, detector 1212 may perform serial to parallel processing of M times of the received signal to M processing streams, with M being a positive integer greater than 1. Moreover, detector 1212 may combine outputs of the M streams coherently or non-coherently.

In some implementations, each of the M processing streams may include a two-stage pipeline performing operations including the following: (1) phase-unwrapping the received signal to provide a phase-unwrapped signal; and (2) performing sample-by-sample sliding DFT on the phase-unwrapped signal. Alternatively, each of the M processing streams may include a three-stage pipeline performing operations including the following: (1) phase-unwrapping the received signal to provide a phase-unwrapped signal; (2) performing partially overlapped sliding DFT on the phase-unwrapped signal to detect a window containing the even-length ZC sequence; and (3) performing sample-by-sample sliding DFT in the detected window.

In some implementations, the signal may include a composite sequence composed of first and second even-length ZC sequences having first and second root indices different from each other. In such cases, in detecting the even-length ZC sequence in the received signal, detector 1212 may execute a first correlator process (e.g., using first correlator 1214) and a second correlator process (e.g., using second correlator 1216) in parallel and then determine a time-frequency offset based on results of the first and second correlator processes. For instance, in executing the first correlator process, first correlator 1214 may perform a number of operations including the following: (1) phase-unwrapping the received signal to provide a first phase-unwrapped signal; (2) performing partially overlapped sliding DFT on the first phase-unwrapped signal; (3) detecting a first window containing the first even-length ZC sequence based on a result of the partially overlapped sliding DFT on the first phase-unwrapped signal; and (4) detecting the first index of a first maximum DFT output. Similarly, in executing the second correlator process, second correlator 1216 may perform a number of operations including the following: (1) phase-unwrapping the received signal to provide a second phase-unwrapped signal; (2) performing partially overlapped sliding DFT on the second phase-unwrapped signal; (3) detecting a second window containing the second even-length ZC sequence based on a result of the partially overlapped sliding DFT on the second phase-unwrapped signal; and (4) detecting the second index of a second maximum DFT output. Moreover, detector 1212 may determine the time-frequency offset by solving linear equations of the first index of the first maximum DFT output, the second index of the second maximum DFT output, a root index of the first even-length ZC sequence, and a root index of the second even-length ZC sequence.

It is noteworthy that the description above with respect to the capabilities of processor 1210 (and communication apparatus 1202 in general) is applicable to processor 1240 (and network apparatus 1204 in general), and vice versa. That is, processor 1240 may perform operations, functions and actions of processor 1210 as described above, and network apparatus 1204 may perform operations, functions and actions of communication apparatus 1202 as described above. Likewise, processor 1210 may perform operations, functions and actions of processor 1240 as described above, and communication apparatus 1202 may perform operations, functions and actions of network apparatus 1204 as described above.

### Illustrative Processes

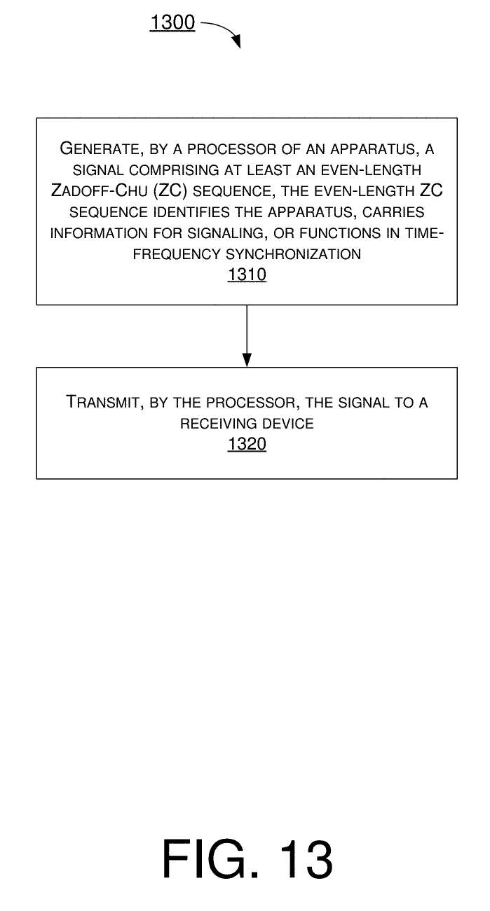

FIG. 13 illustrates an example process 1300 in accordance with an implementation of the present disclosure. Process 1300 may represent an aspect of implementing the proposed concepts and schemes such as one or more of the various schemes, concepts, embodiments and examples described above with respect to FIG. 1˜FIG. 11. More specifically, process 1300 may represent an aspect of the proposed concepts and schemes pertaining to using even-length sequence for synchronization and device identification in wireless communications. For instance, process 1300 may be an example implementation, whether partially or completely, of the proposed schemes, concepts and examples described above from a TX perspective for using even-length sequence for synchronization and device identification in wireless communications. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Process 1300 may also include additional operations and/or acts not shown in FIG. 13. Moreover, the blocks of process 1300 may be executed in the order shown in FIG. 13 or, alternatively in a different order. The blocks of process 1300 may be executed iteratively. Process 1300 may be implemented by or in apparatus 1202 and apparatus 1204 as well as any variations thereof. Solely for illustrative purposes and without limiting the scope, process 1300 is described below with reference to apparatus 1202. Process 1300 may begin at block 1310.

At 1310, process 1300 may involve processor 1210 of apparatus 1202 generating a signal comprising at least an even-length ZC sequence. The even-length ZC sequence may identify apparatus 1202, carry information for signaling, or function in time-frequency synchronization. Process 1300 may proceed from 1310 to 1320.

At 1320, process 1300 may involve processor 1210 transmitting, via transmitter 1232 of transceiver 1230 of apparatus 1202, the signal to a receiving device (e.g., receiver 1264 of transceiver 1260 of apparatus 1204).

In some implementations, a length of the even-length ZC sequence may be a power of 2.

In some implementations, in generating the signal comprising the even-length ZC sequence, process 1300 may involve processor 1210 generating the even-length ZC sequence in a time domain. Alternatively, in generating the signal comprising the even-length ZC sequence, process 1300 may involve processor 1210 generating the even-length ZC sequence in a frequency domain.

In some implementations, the even-length ZC sequence may function for either or both of device identification and signaling. In such cases, in transmitting the signal, process 1300 may involve processor 1210 transmitting, via transmitter 1232, the even-length ZC sequence with information of either or both of device identification and signaling carried by either of: (1) a cyclic or non-cyclic time-frequency shift of the even-length ZC sequence and (2) a root index of the even-length ZC sequence.

In some implementations, in generating the signal, process 1300 may involve processor 1210 generating the signal by synthesizing two or more even-length ZC sequences into a composite sequence.

In some implementations, in synthesizing the two or more even-length ZC sequences into the composite sequence, process 1300 may involve processor 1210 synthesizing the two or more even-length ZC sequences using: (1) contiguous or non-contiguous FDM or interleaved FDM, (2) contiguous or non-contiguous TDM or interleaved TDM, (3) CDM, or (4) a combination of some or all of the FDM, TDM and CDM (e.g., FDM plus TDM, FDM plus CDM, TDM plus CDM, or FDM plus TDM plus CDM).

In some implementations, the two or more even-length ZC sequences may be of a same length. Alternatively, the two or more even-length ZC sequences may be of different lengths.

In some implementations, the two or more even-length ZC sequences may have a same root index. Alternatively, the two or more even-length ZC sequences may have different root indices.

In some implementations, the two or more even-length ZC sequences may include two even-length ZC sequences having two different root indices, and the two different root indices may be conjugate to each other.

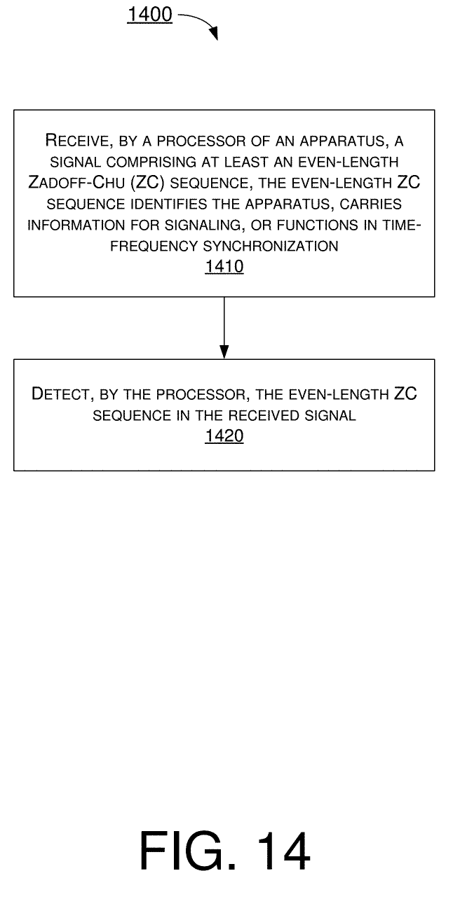

FIG. 14 illustrates an example process 1400 in accordance with an implementation of the present disclosure. Process 1400 may represent an aspect of implementing the proposed concepts and schemes such as one or more of the various schemes, concepts, embodiments and examples described above with respect to FIG. 1˜FIG. 11. More specifically, process 1400 may represent an aspect of the proposed concepts and schemes pertaining to using even-length sequence for synchronization and device identification in wireless communications. For instance, process 1400 may be an example implementation, whether partially or completely, of the proposed schemes, concepts and examples described above from a RX perspective for using even-length sequence for synchronization and device identification in wireless communications. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Process 1400 may also include additional operations and/or acts not shown in FIG. 14. Moreover, the blocks of process 1400 may be executed in the order shown in FIG. 14 or, alternatively in a different order. The blocks of process 1400 may be executed iteratively. Process 1400 may be implemented by or in apparatus 1202 and apparatus 1204 as well as any variations thereof. Solely for illustrative purposes and without limiting the scope, process 1400 is described below with reference to apparatus 1202. Process 1400 may begin at block 1410.

At 1410, process 1400 may involve processor 1210 of apparatus 1202 receiving, via receiver 1234 of transceiver 1230 of apparatus 1202, a signal comprising at least an even-length ZC sequence (e.g., from apparatus 1204). The even-length ZC sequence may identify apparatus 1204, carry information for signaling, or function in time-frequency synchronization. Process 1400 may proceed from 1410 to 1420.

At 1420, process 1400 may involve processor 1210 detecting the even-length ZC sequence in the received signal.

In some implementations, in detecting the even-length ZC sequence in the received signal, process 1400 may involve processor 1210 performing a number of operations (e.g., to execute logic flow 400 as described above). For instance, process 1400 may involve processor 1210 phase-unwrapping the received signal to provide a phase-unwrapped signal. Additionally, process 1400 may involve processor 1210 performing sample-by-sample sliding DFT on the phase-unwrapped signal. Moreover, process 1400 may involve processor 1210 identifying a maximum correlation output based on a result of the sample-by-sample DFT. Furthermore, process 1400 may involve processor 1210 determining a time-frequency offset using the maximum correlation output.

In some implementations, in detecting the even-length ZC sequence in the received signal, process 1400 may involve processor 1210 performing a number of operations (e.g., to execute logic flow 700 as described above). For instance, process 1400 may involve processor 1210 phase-unwrapping the received signal to provide a phase-unwrapped signal. Additionally, process 1400 may involve processor 1210 performing partially overlapped sliding DFT on the phase-unwrapped signal. Moreover, process 1400 may involve processor 1210 detecting a window containing the even-length ZC sequence based on a result of the partially overlapped sliding DFT. Furthermore, process 1400 may involve processor 1210 performing sample-by-sample sliding DFT in the detected window to determine a time-frequency offset.

In some implementations, in detecting the even-length ZC sequence in the received signal, process 1400 may involve processor 1210 over-sampling the received signal in a frequency domain such that a resolution of detection of the even-length ZC sequence is increased. In some implementations, in over-sampling the received signal in the frequency domain, process 1400 may involve processor 1210 performing a zero-padded sliding DFT on the received signal.

In some implementations, in detecting the even-length ZC sequence in the received signal, process 1400 may involve processor 1210 over-sampling the received signal in a time domain such that a range of detection of the even-length ZC sequence in a frequency domain is increased. In some implementations, in over-sampling the received signal in the time domain, process 1400 may involve processor 1210 performing serial to parallel processing of M times of the received signal to M processing streams, with M being a positive integer greater than 1. Moreover, process 1400 may involve processor 1210 combining outputs of the M streams coherently or non-coherently.

In some implementations, each of the M processing streams may include a two-stage pipeline performing a number of operations including the following: (1) phase-unwrapping the received signal to provide a phase-unwrapped signal; and (2) performing sample-by-sample sliding DFT on the phase-unwrapped signal. Alternatively, each of the M processing streams may include a three-stage pipeline performing a number of operations including the following: (1) phase-unwrapping the received signal to provide a phase-unwrapped signal; (2) performing partially overlapped sliding DFT on the phase-unwrapped signal to detect a window containing the even-length ZC sequence; and (3) performing sample-by-sample sliding DFT in the detected window.

In some implementations, the signal may include a composite sequence composed of first and second even-length ZC sequences having first and second root indices different from each other. In such cases, in detecting the even-length ZC sequence in the received signal, process 1400 may involve processor 1210 executing a first correlator process and a second correlator process in parallel and determining a time-frequency offset based on results of the first and second correlator processes (e.g., to execute logic flow 1100 as described above). In executing the first correlator process, process 1400 may involve processor 1210 performing the following: (1) phase-unwrapping the received signal to provide a first phase-unwrapped signal; (2) performing partially overlapped sliding DFT on the first phase-unwrapped signal; (3) detecting a first window containing the first even-length ZC sequence based on a result of the partially overlapped sliding DFT on the first phase-unwrapped signal; and (4) detecting the first index of a first maximum DFT output. In executing the second correlator process, process 1400 may involve processor 1210 performing the following: (1) phase-unwrapping the received signal to provide a second phase-unwrapped signal; (2) performing partially overlapped sliding DFT on the second phase-unwrapped signal; (3) detecting a second window containing the second even-length ZC sequence based on a result of the partially overlapped sliding DFT on the second phase-unwrapped signal; and (4) detecting the second index of a second maximum DFT output.

In some implementations, in determining the time-frequency offset based on results of the first and second correlator processes, process 1400 may involve processor 1210 solving linear equations of the first index of the first maximum DFT output, the second index of the second maximum DFT output, a root index of the first even-length ZC sequence, and a root index of the second even-length ZC sequence.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of an apparatus, a signal comprising at least an even-length Zadoff-Chu (ZC) sequence; and
transmitting, by the processor, the signal to a receiving device,
wherein the even-length ZC sequence identifies the apparatus, carries information for signaling, or functions in time-frequency synchronization.

2. The method of claim 1, wherein a length of the even-length ZC sequence is a power of 2.

3. The method of claim 1, wherein the generating of the signal comprising the even-length ZC sequence comprises generating the even-length ZC sequence in a time domain.

4. The method of claim 1, wherein the generating of the signal comprising the even-length ZC sequence comprises generating the even-length ZC sequence in a frequency domain.

5. The method of claim 1, wherein the even-length ZC sequence functions for either or both of device identification and signaling, and wherein the transmitting of the signal comprises transmitting the even-length ZC sequence with information of either or both of device identification and signaling carried by either of:
a cyclic or non-cyclic time-frequency shift of the even-length ZC sequence; and
a root index of the even-length ZC sequence.

6. The method of claim 1, wherein the generating of the signal comprises generating the signal by synthesizing two or more even-length ZC sequences into a composite sequence.

7. The method of claim 6, wherein the synthesizing of the two or more even-length ZC sequences into the composite sequence comprises synthesizing the two or more even-length ZC sequences using:
contiguous or non-contiguous frequency division multiplexing (FDM) or interleaved FDM;
contiguous or non-contiguous time division multiplexing (TDM) or interleaved TDM;
code division multiplexing (CDM); or
a combination of some or all of the FDM, TDM and CDM.

8. The method of claim 6, wherein the two or more even-length ZC sequences have a same root index.

9. The method of claim 6, wherein the two or more even-length ZC sequences have different root indices.

10. The method of claim 9, wherein the two or more even-length ZC sequences comprise two even-length ZC sequences having two different root indices, and wherein the two different root indices are conjugate to each other.

11. A method, comprising:
receiving, by a processor of an apparatus, a signal comprising at least an even-length Zadoff-Chu (ZC) sequence; and
detecting, by the processor, the even-length ZC sequence in the received signal,
wherein the even-length ZC sequence identifies the apparatus, carries information for signaling, or functions in time-frequency synchronization.

12. The method of claim 11, wherein the detecting of the even-length ZC sequence in the received signal comprises:
phase-unwrapping the received signal to provide a phase-unwrapped signal;
performing sample-by-sample sliding Discrete Fourier Transform (DFT) on the phase-unwrapped signal;
identifying a maximum correlation output based on a result of the sample-by-sample DFT; and
determining a time-frequency offset using the maximum correlation output.

13. The method of claim 11, wherein the detecting of the even-length ZC sequence in the received signal comprises:
phase-unwrapping the received signal to provide a phase-unwrapped signal;
performing partially overlapped sliding Discrete Fourier Transform (DFT) on the phase-unwrapped signal;
detecting a window containing the even-length ZC sequence based on a result of the partially overlapped sliding DFT; and
performing sample-by-sample sliding DFT in the detected window to determine a time-frequency offset.

14. The method of claim 11, wherein the detecting of the even-length ZC sequence in the received signal comprises over-sampling the received signal in a frequency domain such that a resolution of detection of the even-length ZC sequence is increased.

15. The method of claim 14, wherein the over-sampling of the received signal in the frequency domain comprises performing a zero-padded sliding Discrete Fourier Transform (DFT) on the received signal.

16. The method of claim 11, wherein the detecting of the even-length ZC sequence in the received signal comprises over-sampling the received signal in a time domain such that a range of detection of the even-length ZC sequence in a frequency domain is increased.

17. The method of claim 16, wherein the over-sampling of the received signal in the time domain comprises:
performing serial to parallel processing of M times of the received signal to M processing streams; and
combining outputs of the M streams coherently or non-coherently.
wherein M is a positive integer greater than 1.

18. The method of claim 17, wherein each of the M processing streams comprises a two-stage pipeline performing operations comprising:
phase-unwrapping the received signal to provide a phase-unwrapped signal; and
performing sample-by-sample sliding Discrete Fourier Transform (DFT) on the phase-unwrapped signal.

19. The method of claim 17, wherein each of the M processing streams comprises a three-stage pipeline performing operations comprising:
phase-unwrapping the received signal to provide a phase-unwrapped signal;
performing partially overlapped sliding Discrete Fourier Transform (DFT) on the phase-unwrapped signal to detect a window containing the even-length ZC sequence; and
performing sample-by-sample sliding DFT in the detected window.

20. The method of claim 11, wherein the signal comprises a composite sequence composed of first and second even-length ZC sequences having first and second root indices different from each other, wherein the detecting of the even-length ZC sequence in the received signal comprises executing a first correlator process and a second correlator process in parallel and determining a time-frequency offset based on results of the first and second correlator processes, and wherein:
the first correlator process comprises:
phase-unwrapping the received signal to provide a first phase-unwrapped signal;
performing partially overlapped sliding Discrete Fourier Transform (DFT) on the first phase-unwrapped signal;
detecting a first window containing the first even-length ZC sequence based on a result of the partially overlapped sliding DFT on the first phase-unwrapped signal; and
detecting the first index of a first maximum DFT output, and
the second correlator process comprises:
phase-unwrapping the received signal to provide a second phase-unwrapped signal;
performing partially overlapped sliding DFT on the second phase-unwrapped signal;
detecting a second window containing the second even-length ZC sequence based on a result of the partially overlapped sliding DFT on the second phase-unwrapped signal; and
detecting the second index of a second maximum DFT output.
the determining of the time-frequency offset comprises:
solving linear equations of the first index of the first maximum DFT output, the second index of the second maximum DFT output, a root index of the first even-length ZC sequence, and a root index of the second even-length ZC sequence.
